(19) United States
(12) Patent Application Publication
(10) Pub. No.: US 2016/0142380 A1
(43) Pub. Date: May 19, 2016

(54) SYSTEMS AND METHODS FOR MAINTAINING USER PRIVACY AND SECURITY OVER A COMPUTER NETWORK AND/OR WITHIN A RELATED DATABASE

(71) Applicant: rocket-fueled, Inc., Decatur, AL (US)

(72) Inventors: David A. Fuller, Decatur, AL (US); Joshua S. Hogue, Harvest, AL (US)

(21) Appl. No.: 14/945,989

(22) Filed: Nov. 19, 2015

Related U.S. Application Data
(60) Provisional application No. 62/081,941, filed on Nov. 19, 2014.

(51) Int. Cl. H04L 29/06

(52) U.S. Cl. CPC H04L 63/0421; H04L 63/083

(57) ABSTRACT

Systems and methods are provided to maintain the privacy of a user's actions and/or experiences on a computer network. The user's privacy is maintained by making the user, the user's data and the user's tracks anonymous to network operators and content providers, while supporting pattern analysis for purposes including, but not limited to, analytics, reputation management, search, discovery, hashtag or geotag management. Unique and dynamically generated tokens are used to make the user's identity and actions anonymous during the user's activities, exchanges or communications on the computer network. Collected information regarding the actions of the anonymous users can be used to generate analytical data. However, the collected information is not associated with an individual user unless that user is a registered user and even then, a specific user's data and track are only available to that user. If a registered user requests his/her information, the information is provided to the user in an encrypted format using a public key provided by the user and can only be decrypted with a private key held by the user.

### CROSS-REFERENCE TO RELATED APPLICATIONS

This application claims the benefit of U.S. Provisional Application No. 62/081,941, entitled “Systems and Methods for Maintaining User Privacy and Security over a Computer Network and/or within a Related Database,” and filed Nov. 19, 2014, which application is hereby incorporated by reference in its entirety.

### BACKGROUND

The present application generally relates to systems and methods for maintaining user privacy and security.

When a user is using a computer network, e.g., browsing websites on the Internet, using mobile applications, accessing connected systems, e.g., stand-alone terminals or devices, associated with businesses, venues, events, experiences, transactions or interactions whether between people, between people and things, between people and places, between people and content (in whatever form including, but not limited to text, images and/or video) and/or any combination thereof; or when sending messages, notifications, emails or other forms of communications, the user's activities and behaviors can be monitored and/or tracked to provide information on the user's performance, preferences and experiences when using the computer network. One type of system that can be used to monitor user activities on a computer network is a user analytics system.

A user analytics system records, discovers, evaluates, prioritizes and reports patterns of user behavior. The user analytics system may be used to track user activity on a computer network, as well as other devices and/or communication interfaces that receive user input such as email, text messaging, push notifications, or other forms of user communication. For example, a user analytics system can track website, mobile application, connected system and/or network usage and provide various data and statistics about how users navigate to, from and/or through a website, mobile application, connected system and/or network. In addition, the user analytics system can also be used to track specific activities and behaviors of each individual user.

The user analytics system can employ specialized code, such as JavaScript, that runs or executes on a server for a website, mobile application, connected system and/or network to obtain data on such website's, mobile application's, connected system's or network's usage by tracking which digital objects (e.g., images, videos or text) are clicked or otherwise selected by, utilized and/or engaged users and/or by tracking which physical objects (such as, but not limited to, smart things, as in the “Internet of Things”, i.e., smart, sensor equipped and/or connected objects or devices with the ability to collect, receive, process and/or communicate data,) are selected by, utilized by and/or engaged by users. The user analytics system can also track how a user scrolls through the website or mobile application, or detect when events occur on a website, mobile application, connected system or network, or determine, for example, when, where, how and why users engage or access a website, mobile application, connected system or network. The data provided by the user analytics system can be used to provide analysis of user behavior, both individually and as a group, when using the website, mobile application, connected system or network. As an example, a user analytics system may track and report the percentage or number of users that clicked or otherwise selected a certain object or a certain sequence of objects on a website or mobile application or engaged in an activity, which corresponds to a detected event, on a connected system or network.

The owner or content provider of the website, mobile application or connected system or network can then use the obtained analytics information to improve the operation of the website, mobile application, connected system or network and to customize each user's experience when using the website, mobile application, connected system or network. However, many users do not want their activities and behaviors tracked over concerns relating to the privacy and security of the user's information.

Therefore, what is needed are systems and methods to keep individual user activities and behaviors on a computer network private and secure from others while permitting users to collect general, i.e., not user-specific, information and data on counter-party activities and behaviors, yet retain the ability to perform detailed pattern analysis vital to creating optimal user experiences and/or outcomes.

### SUMMARY

The present application generally pertains to systems and methods for maintaining the privacy of a user's actions and/or experiences on a computer network, e.g., the Internet, an Intranet, a wide area network (WAN) or a local area network (LAN). The user's privacy is maintained by making the user, the user's data and the user's tracks anonymous to network operators, content or item providers, or website, mobile application and connected system operators. Tokens are used to make the user's identity and actions anonymous during exchanges or communications on the computer network involving the user's actions or activities. The tokens are unique and dynamically generated for each use or session by a user. Collected information regarding the actions of the anonymous users can be used to generate analytical data and stored in an encrypted format with the generated analytical data. However, the collected information is not associated with an individual user unless that user is a registered user and requests his/her information. If a registered user requests his/her information, the information is provided to the user in an encrypted format using a public key provided by the user, such that the information can only be decrypted with the corresponding private key held by the user.

One advantage of the present application is that users, user data and user tracks are anonymous to the network operator, the content or item provider, or the website, mobile application or connected system operator.

Another advantage of the present application is that double-blind encrypted tokens and cryptograms protect the privacy of providers, operators and users during each and every exchange.

Still another advantage of the present application is that users can have all the benefits of the data generated from their activities without sacrificing privacy or security.

Other features and advantages of the present application will be apparent from the following more detailed description of the identified embodiments, taken in conjunction with the accompanying drawings which show, by way of example, the principles of the application.

### BRIEF DESCRIPTION OF THE DRAWINGS

FIG. 1 is a block diagram showing an embodiment of a computer system.

FIG. 2 is a block diagram showing an embodiment of a webpage of a website, a screen of a mobile application, objects on a connected system and/or a portal of a network.

FIG. 3 is a block diagram showing an embodiment of a user analytics server.

FIG. 4 shows an exemplary embodiment of a process for obtaining and processing anonymous data.

FIG. 5 shows an exemplary embodiment of a process for a user to access anonymously stored data.

FIGS. 6 and 7 are diagrams showing embodiments of the partitioned provider, consumer and network operator data repositories in a user analytics server.

Wherever possible, the same reference numbers are used throughout the drawings to refer to the same or like parts.

### DETAILED DESCRIPTION

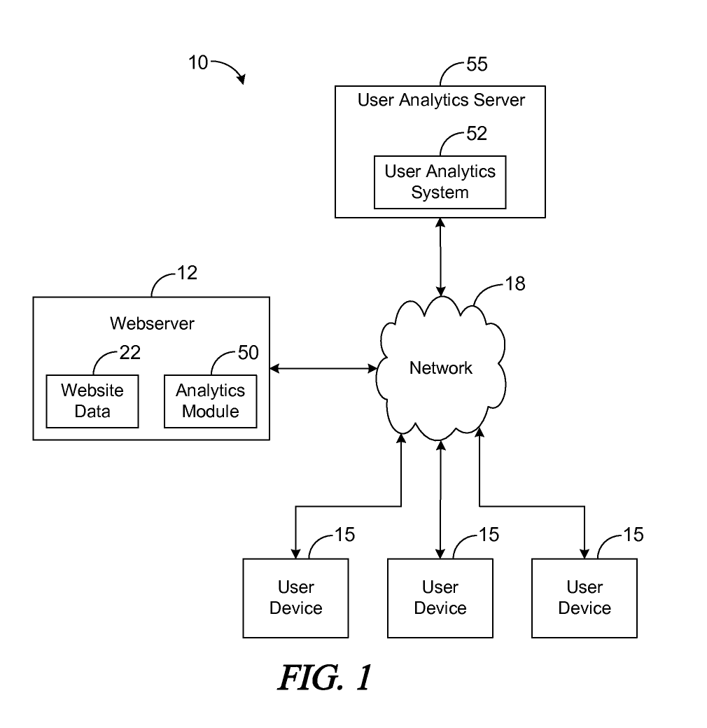

FIG. 1 shows an embodiment of a computer system 10. The system 10 includes a webserver 12 for hosting a website, a mobile application and/or a connected system which can be accessed by one or more user devices 15 over a network 18. Each user device 15 is communicatively coupled to the network 18 to exchange, i.e., send and receive, instructions, data and/or information with the webserver 12. The user device 15 can be, but is not limited to, a desktop, laptop or tablet computer, a hand-held device, such as a cellular telephone (e.g., smartphone) or portable gaming device, a television, a video game system, a still and/or video camera, an attachable, wearable, implantable or non-invasive computer or device, and/or a smart thing. The user device 15 can have one or more input devices to permit a user to enter instructions, data and/or information for the webserver 12 and one or more output devices to permit the user to display instructions, data and/or information received from the webserver 12.

In one embodiment, the network 18 can be the Internet and use the transmission control protocol/Internet protocol (TCP/IP) to communicate over the network 18. However, in other embodiments, the network 18 may be an Intranet, a local area network (LAN), a wide area network (WAN), a Near Field Communication (NFC) Peer to Peer network, Internet of Things, or any other type of communication network using one or more communication protocols.

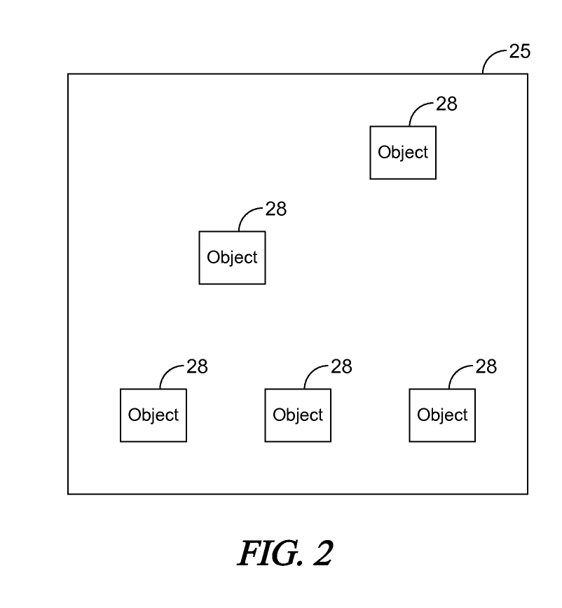

The webserver 12 can, for example, store website data 22 that defines a website that can be accessed by any of the user devices 15. The exemplary website data 22 may include one or more webpages that can be retrieved and rendered by the user device 15. FIG. 2 shows a webpage 25 defined by the website data 22 and displayed to a user by a user device 15. The webpage 25 may have numerous objects 28, such as, but not limited to, images, videos, text, or selectable icons for triggering various user events. A user may enter inputs into the user device 15 displaying the webpage 25 in order to select one or more of the objects 28. For example, an object 28 may be a thumbnail image that is expanded to a larger image when selected by a user input. An object 28 may also be a video or audio file that is played when selected by user input, or an object 28 may define text selectable by a user. Some of the objects 28, when selected by the user, may direct the user to a different webpage. In other embodiments, webpage 25 may correspond to a “screen” or interface of a mobile application, objects on a connected system and/or a portal of a network.

In order to provide information to the website owner or content provider regarding the user's actions at the website, an analytical system can record the user's navigation and activity through the website. An example of an analytical system that can be used with the present application is described in commonly-assigned U.S. patent application Ser. No. 14/921,744, entitled “Systems and Methods for Providing User Analytics” and filed on Oct. 23, 2015, which is incorporated herein by reference.

The analytical system can include a user analytics server 55, an analytics module 50 and a user analytics system 52. In one embodiment, the analytics module 50 can reside on the webserver 12 and communicate with the user analytics system 52 that is hosted by user analytics server 55. The analytics module 50 may include software (e.g., one or more JavaScript programs) that can be downloaded to the webserver 12 from the user analytics server 55 or other source. The analytics module 50 may run or execute on the webserver 12 and interact with the user analytics system 52 (over the network 18) for tracking how users navigate through the website hosted by the webserver 12.

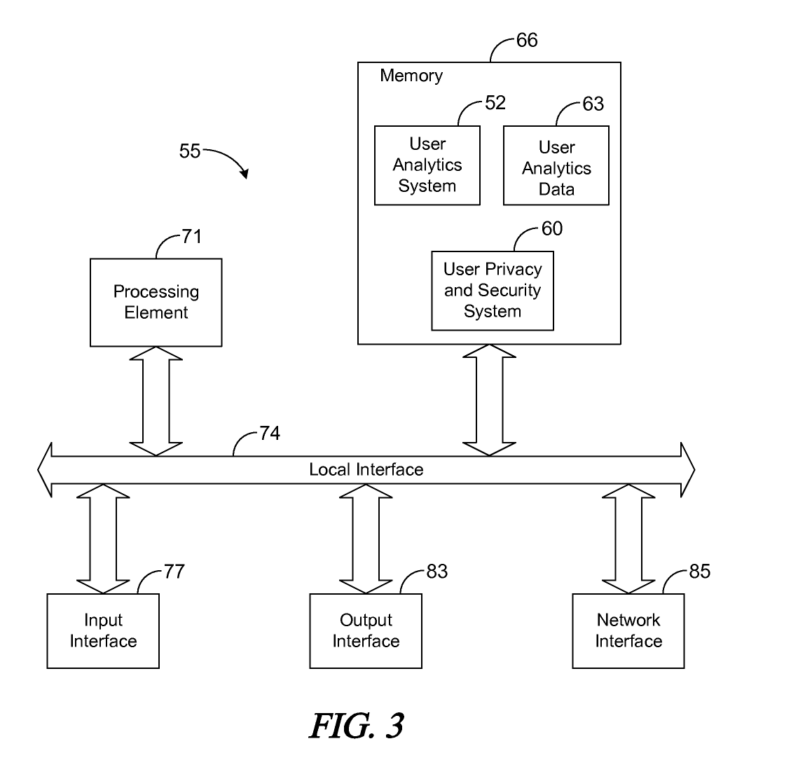

FIG. 3 shows an embodiment of the user analytics server 55. The user analytics server 55 includes the user analytics system 52, which can be implemented in software, hardware, firmware or any combination thereof. In the server 55 shown in FIG. 3, the user analytics system 52 is implemented in software and stored in memory 66. Note that, as described above, the analytics module 50 may also be implemented in software, but other configurations of the user analytics system 52 and the analytics module 50 are possible in other embodiments.

The user analytics system 52 or the analytics module 50, when implemented in software, can be stored and transported on any non-transitory computer-readable medium for use by or in connection with an instruction execution apparatus, e.g., a microprocessor, that can fetch and execute instructions. In the context of this application, a “computer-readable medium” can be any device, system or technique that can contain or store a computer program for use by or in connection with an instruction execution apparatus.

The user analytics server 55 shown by FIG. 3 includes at least one conventional processing element 71, such as a digital signal processor (DSP) or a central processing unit (CPU), that communicates to and drives the other elements within the user analytics server 55 via a local interface 74, which can include at least one bus. Furthermore, an input interface 77, for example, a keyboard, a mouse, touchscreen, sensor or any other interface device or apparatus, can be used to input data from a user of the server 55, and an output interface 83, for example, a printer, monitor, liquid crystal display (LCD), or other display apparatus, can be used to output data to the user of the server 55. Further, a network interface 85, such as at least one modem, may be used to exchange data with the network 18.

Referring back to FIG. 1, the analytics module 50 may monitor navigational commands from the user devices 15 to determine when certain user events or actions occur, such as a selection of a certain object 28. However, the analytical system can incorporate a user privacy and security system 60 (see FIG. 3) such that when the analytics module 50 communicates with the user analytics server 55 regarding an event or action of the user, no identifying information relating to the user is provided to the user analytics server 55 and the user is anonymous to the user analytics server 55. The user privacy and security system 60 can be implemented in software, hardware, firmware or any combination thereof. In the server 55 shown in FIG. 3, the user privacy and security system 60 can be implemented in software and stored in memory 66. Note that while the user privacy and security system 60 may be implemented in software, other configurations of the user privacy and security system 60 are possible in other embodiments. The user privacy and security system 60, when implemented in software, can be stored and transported on any non-transitory computer-readable medium for use by or in connection with an instruction execution apparatus, e.g., a microprocessor, that can fetch and execute instructions.

To make the user's actions and events with a website, mobile application, connected system or network anonymous, a temporary, dynamically generated, single-use token is provided to the analytics module 50 and/or webserver 12 by the user privacy and security system 60. The token provided by the user privacy and security system 60 may then be used by the analytics module 50 for a specific exchange or throughout the user's session with, for example, the website and/or webserver 12.

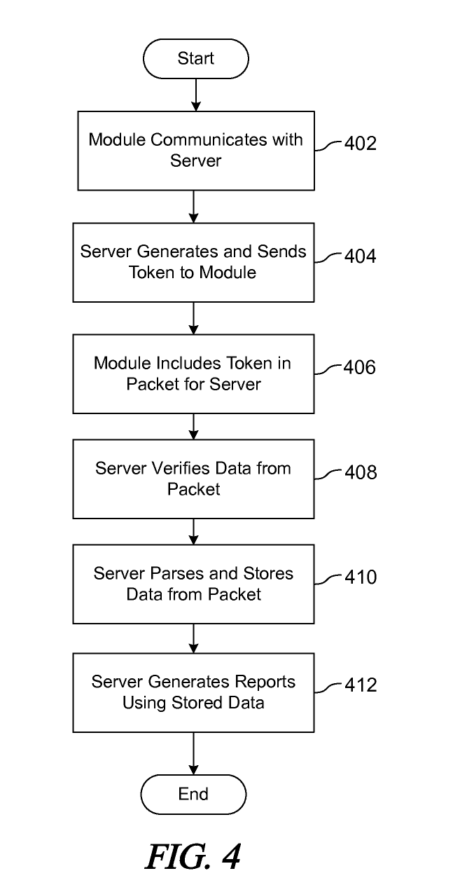

FIG. 4 shows an exemplary embodiment of a process for obtaining and processing anonymous data. The process begins with a module, e.g., the analytics module 50, making an initial communication with a server, e.g., the user analytics server 55 (step 402). The initial communication can occur in response to a user accessing a website monitored by the analytics module 50. A token is then generated and sent to the analytics module 50 and/or webserver 12 by the user privacy and security system 60 in the user analytics server 55 (step 404) in response to the initial communication by the analytics module 50. In one embodiment, the user analytics server 55 can be configured or setup to work only with data, e.g., analytics data, that has an accompanying token.

The token provided to the analytics module 50 and/or webserver 12 can include address information related to the IP (Internet Protocol) address or other identifier of the user device 15 used to access the website, including, but not limited to, a proxy IP address to maintain the privacy of the user's identity and/or physical location. The address information included in the token by the user privacy and security system 60 can be provided by the analytics module 50 in the initial communication between the analytics module 50 and the analytics server 55. The token can also include information on the web browser and/or operating system of the user device 15, which information can also be provided in the initial communication between the analytics module 50 and the analytics server 55, some random data that is inserted to obfuscate the other data in the token once the token has been hashed and/or encrypted, and “identification” information. The “identification” information may only be relevant when the user is a registered user of the user analytics server 55. In one embodiment, the user privacy and security system 60 can generate the “identification” information using an encrypted combination of data that may include a user's unique ID (identification) assigned on registration, the user's private key (which only the user knows), a session ID, an IP (Internet Protocol) address, server entropy, and other data fields. New “identification” information is generated each time a token is generated even if the user does not change. If the user is not a registered user, e.g., a guest user, the “identification” information is randomly generated for that session and can be discarded at the completion of the session. In one embodiment, the actions of a registered user who has not “signed in” with the analytics server 55 are handled the same as a guest or non-registered user.

When the analytics module 50 is ready to communicate analytics data or other information relating to a user action, event or activity during a session on the website, the analytics module 50 prepares a packet that includes the token (step 406) provided by the user privacy and security system 60 (after the token has been hashed by a preselected hashing function). The packet also includes analytics data associated with the user action and some identifying data, e.g., the IP address or other identifier of the user device 15, to permit the user analytics server 55 to verify that the analytics data should be associated with the token. The packet to be sent to the user analytics server 55 by the analytics module 50 may be encrypted to provide security for the data.

In one embodiment, the analytics module 50 and/or webserver 12 can hash the token using the preselected hashing function each time a message is to be sent to the user analytics server 55. In another embodiment, the analytics module 50 and/or webserver 12 can immediately hash the token using the preselected hashing function after receiving the token from the user analytics server 55 and then use the hashed token for communications with the user analytics server 55. In still another embodiment, the user analytics server 55 can send a hashed token to the analytics module 50 and/or webserver 12 for use in communications with the user analytics server 55.

When the user analytics server 55, specifically, the user analytics system 52, receives the packet from the analytics module 50, the user analytics system 52 can decrypt the packet (if encrypted), de-hash the token using the corresponding de-hashing function, and verify that the packet data is associated with the token (step 408) by comparing the identifying data in the packet with the corresponding address information in the token. The user analytics server 55 can process or parse the packet data and save the packet data (step 410). The stored packet data can include the anonymous “identification” information in the token from the packet, regardless of whether the “identification” information is associated with a registered user or is random data. The anonymous “identification” information remains encrypted and inaccessible to the user analytics server 55 when stored. In another embodiment, the user analytics system 52 can discard the anonymous “identification” information of a non-registered or guest user. The user analytics system 52 can save, in an encrypted format, the analytics data in the packet and the anonymous “identification” information, if present, as user analytics data 63 (see FIG. 3). The user analytics system 52 can decrypt the analytics data, if needed, to generate different analytical reports for the website owner or content provider (step 412). In one embodiment, the user analytics server 55 can use rotating, changing or dynamic keys to encrypt the data and a corresponding algorithm to determine which key is needed to decrypt the data.

In one embodiment, the user analytics data 63 can be analyzed by website owners or content providers to determine how anonymous users navigate through a website or any other form of user experience where data may be captured. As an example, for each object 28, the user analytics data 63 may indicate the number of times that the object was selected by users. Since the user analytics data 63 does not contain any user identifying information, the user analytics data cannot be parsed in any way to associate event data with a specific user.

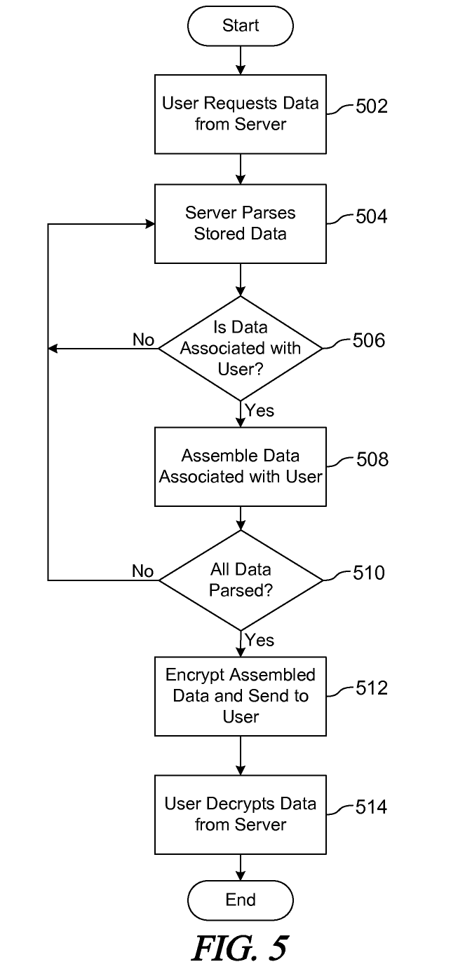

A registered user has the option or capability to view all of the stored data associated with that user. FIG. 5 shows an exemplary embodiment of a process for a user to access anonymously stored data. A registered user authenticates or “signs in” with the user analytics server 55, if not already authenticated or signed in, and requests the user analytics server 55 provide the stored information related to the registered user (step 502) when the registered user wants to view the stored data associated with himself/herself. When the user analytics server 55 receives the request for stored data from a registered user, the user analytics server 55 facilitates a process in which the user's private key is used to identify, clone and assemble all saved and encrypted analytics data related to the user without compiling a record, track or trace of the identity of the user and/or the data harvested by the user's request. The user's private key information can be provided to the user analytics server 55 with the user's request for information. The user analytics server 55 can then scan the stored data for “identification” information corresponding to the user, validate if the private key successfully decrypts the “identification” information, and if so, provide the corresponding analytics data in a secure manner to the user.

When the user analytics server 55 receives the request for information from a registered user, the user analytics server 55 begins parsing the stored data (step 504). As the user analytics server 55 accesses each stored data item, the user analytics server 55 determines if the stored data item is associated with the registered user (step 506). To determine if the stored data item is associated with the registered user, the user analytics server 55 determines whether the private key provided by the user can decrypt the “identification” information in the stored data item to determine whether the “identification” information is associated with the registered user. If the private key provided by the user cannot decrypt the “identification” information, the process returns to step 504 to parse additional stored data items.

However, if the private key provided by the user can decrypt the “identification” information, the stored data item is decrypted, if necessary, and assembled in a “file” associated with the registered user (step 508). The process then continues to determine if all of the stored data items have been parsed (step 510). If all of the stored data items have not been parsed, the process returns to step 504 to parse additional stored data items. If all of the stored data items have been parsed, the user analytics server 55 encrypts the information from the stored data items assembled in the registered user's “file” with a public key provided by the registered user and sends the encrypted information to the user (step 512). The registered user can then decrypt the encrypted information from the user analytics server 55 (step 514) with a private key held by the registered user. In another embodiment, the stored data can be grouped by “identification” information to avoid having to parse the stored data. The user analytics server 55 can just retrieve the grouped data having the “identification” information corresponding to the registered user.

As described above, the user's private key further allows the user to decrypt and review the data associated with the user and assembled by the user analytics server 55. Thus, when the user analytics server 55 finds event data with the “identification” information associated with the registered user, the user analytics server 55 saves the decrypted analytics data in a file accessible only by the user, without the associated “identification” information. During this process, if the stored data does not have the corresponding “identification” information, the user's private key searching by the user analytics server 55 ignores that stored data and moves on to another set of stored data. Once the all of the stored data has been parsed or reviewed by the user's private key and the registered user's data saved in a file, the data is encrypted using both a public key and the private key provided by the registered user. Known public/private key encryption techniques may be used, such as the Advanced Encryption Standard (AES), although other types of encryption may be used in other embodiments. When the user receives the encrypted file from the user analytics server 55, the user can decrypt the data using a private key held by the registered user. The encryption of the registered user's data with keys controlled by the registered user can maintain the security of the data and prevent others from viewing the data.

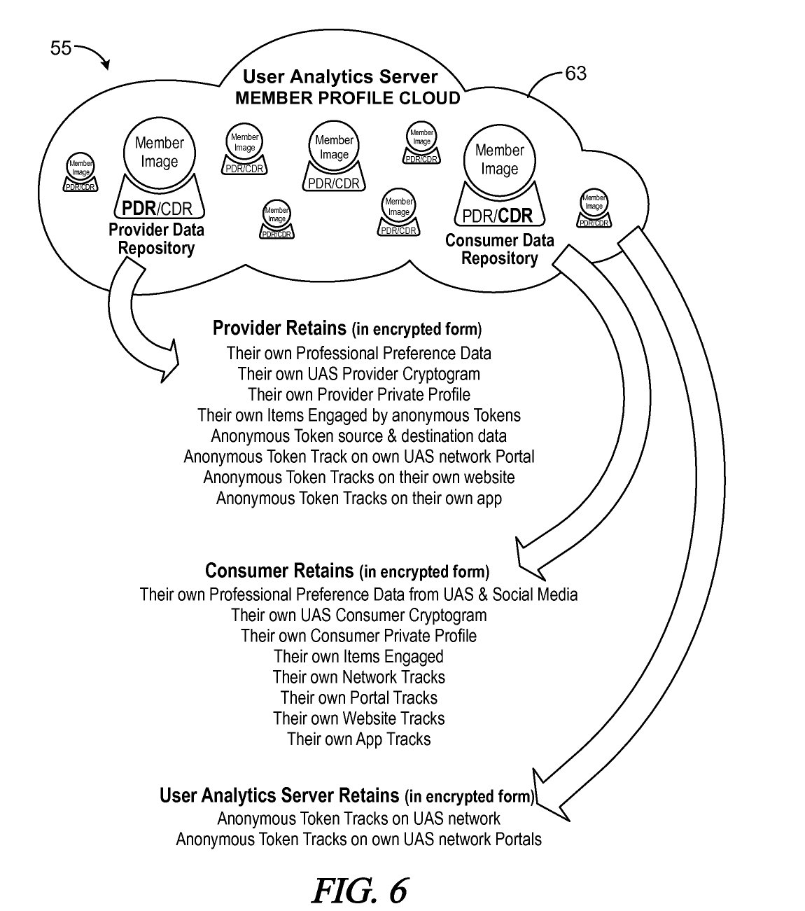

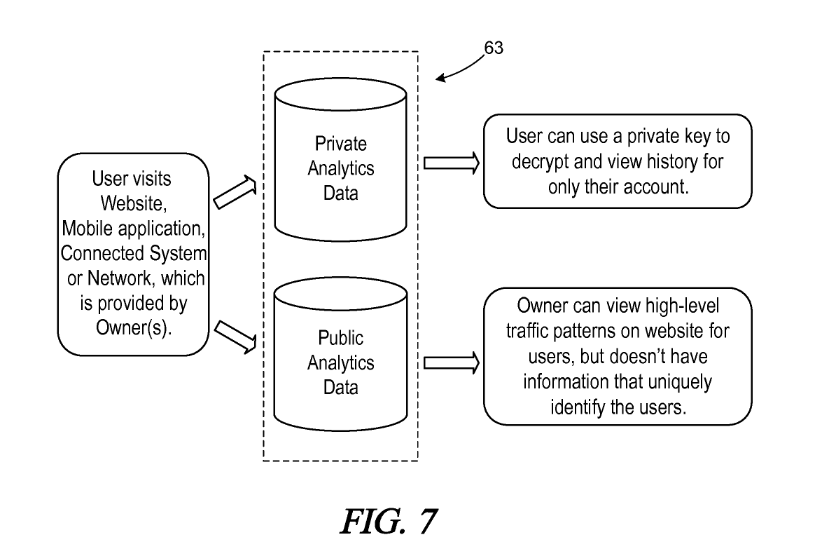

In order for a user to be able to receive the analytics data for his/her/its actions, the user has to register with the user analytics server 55 and be provided with unique “identification” information that is then associated with the user. The registration process is used to link or associate a user with the user's corresponding “identification” information. In one embodiment, the user analytics server 55 cannot link the user to “identification” information unless the authentication or sign-in process is completed by the registered user. By preventing the user analytics server 55 from linking users and “identification” information except through the authentication process, the user analytics server 55 cannot be used to generate any information associated with a user for the webserver 12 (or the website owner). In one embodiment, the stored analytics data can be used for event recording, but the data that is accessible by one user, e.g., a provider, about any other user, e.g., a consumer, does not include linking information to trace back to the original user or account owner. For example, a website, mobile application and/or connected system owner or network provider can see historical records about how another user navigated his/her website, mobile application, connected system or network but doesn't have data to link back to identify the other person. Examples of the only data accessible to a website, mobile application and/or connected system owner or network provider are the city/state, type of device, browser type, and operating system of the user, but may also include other non-identifying data points and/or metrics. The partitioning of this data is reflected in FIGS. 6 and 7.

As shown in FIG. 6, the user analytics data 63 in user analytics server 55 can be partitioned into different data repositories for providers, e.g., website owners and/or content providers, and users or consumers. The provider data repository can be sectioned such that each provider using the user analytics server 55 has a corresponding section. Similarly, the user data repository can be sectioned such that each registered user has a corresponding section. In an alternate embodiment, each user and/or each provider may have their own corresponding data repository. In still another embodiment, the user data repository can be used to store the assembled “files” for each registered user.

The data repository for each provider can include preference data, a cryptogram used by the provider with the user analytics server 55, a private profile (generated when the provider registered with the user analytics server 55), information on items engaged by anonymous token, anonymous token source and destination data, anonymous token tracks on an owner's network portal at the user analytics server 55, anonymous token tracks on an owner's website, anonymous token tracks on an owner's mobile application, anonymous token tracks on an owner's connected system, and/or anonymous token tracks on the operator's network, including, but not limited to, tracks on and/or between owners' portals and the operator's network. The data repository for each registered user can include preference data, a cryptogram used by the user with the user analytics server 55, a private profile (initiated when the registered user registered with the user analytics server 55), and information on items engaged, network tracks, portal tracks, website tracks and mobile application tracks. In addition, the user analytics server 55, which in at least one embodiment may be owned by a third party network operator and/or trusted third party, can store information related to anonymous token tracks on the network 18 and can store information related to anonymous token tracks associated with each provider and user portal at the user analytics server 55.

As shown in FIG. 7, as a user visits or interacts with a website, mobile application or connected system provided by an owner or a content provider and/or the network to which they are connected, the user analytics module 50 can provide analytics data to the user analytics data 63 in user analytics server 55. The user analytics data 63 in user analytics server 55 can partition or divide the analytics data from the analytics module 50 into two different data repositories, i.e., private analytics data and public analytics data. The private analytics data can be encrypted and include user identifying information that must be decrypted by an individual user using a private key supplied by the user. The public analytics data includes high-level information about the user, e.g., browser type, device type, etc., but no unique identifying information about the user, just a session ID to see a historical record in time of the events or actions of the user on the website, mobile application, connected system or network. The user can use a private key (provided by the user) to decrypt and view the analytics data and history for only the user's account. A website, mobile application or connected system owner or content provider can view high-level traffic patterns for the website, mobile application or connected system by one or more users, but doesn't actually have information that uniquely identifies any of the users. Similarly, the network operator of the user analytics system to which such websites, mobile applications or connected systems are linked can view high-level traffic patterns across it's network and the portals through which websites, mobile applications or connected systems are linked by one or more users, but doesn't actually have information that uniquely identifies any of the users.

In one embodiment, the user analytics server 55 can use pattern analysis on the public analytics data to generate the analytics data provided to the owner, content provider or network operator. Pattern analysis includes the storing, analyzing, and presenting of behavior patterns of visitors to a website, mobile application, connected system and/or the network to which they are linked as managed by an administrator. In order to obtain and store pattern analysis data, software on the administrator's website, mobile application, connected system or network is activated by the visitor's device/browser/interface. The software assigns the visitor an anonymous tracking token that permits a record of events to be recorded about the visitor without personally identifying the visitor. If a visitor has not interacted with the website, mobile application, connected system or network within the expiry of the visitor's session period or has never had an initial tracking token generated, a new session and token are generated and assigned to the user. If a user has interacted with the website, mobile application, connected system or network and the user's session period has not yet expired, the session period is extended and the same tracking token may be used. Token lifetimes and session expiry may be varied to enhance privacy and security. The session period may be configurable by the administrator based on the specific website, mobile application, connected system or network being evaluated. When a visitor interacts with the website, mobile application, connected system or network and generates a behavior event, data such as the event details, time of event, and anonymous tracking token are stored. Table 1 shows an example of events stored, where an event may be of type A, B, C or D.

TABLE 1

| | Event 1 | Event 2 | Event 3 | Event 4 |
|---|---|---|---|---|
| Visitor 1 | A | A | B | B |
| Visitor 2 | A | B | C | D |
| Visitor 3 | A | A | B | C |
| Visitor 4 | A | A | C | A |

A website, mobile application, connected system or network administrator may generate reports that present and/or illustrate the pattern analysis data. To build the analysis data structures, the server reviews the first behavior event of each visitor to a website, mobile application, connected system or network and creates a “flow node” for each visitor, appending this flow node to a “flow path” for the visitor, and calculating a running checksum for the flow path. The checksum is based upon the data from any previous and most recent flow nodes for the visitor, and multiple visitors may have the same checksum at different points in their respective flow paths. On subsequent behavior events for each visitor, a flow node is created for the visitor's behavior event and the flow node is added to the visitor's flow path, with the checksum again updated based upon the visitor's prior flow path and new flow node data. The process may be repeated for any number of iterations depending upon the total length of flow nodes for each visitor. Table 2 shows an example of analysis data structures.

TABLE 2

| | Flow Node 1 | Flow Node 2 | Flow Node 3 | Flow Node 4 |
|---|---|---|---|---|
| Visitor A | A | A-A | A-A-B | A-A-B-B |
| Visitor B | A | A-B | A-B-C | A-B-C-D |
| Visitor C | A | A-A | A-A-B | A-A-B-C |
| Visitor D | A | A-A | A-A-C | A-A-C-A |

To complete analysis on the data structures, each flow path from each visitor is iterated across. Groups of flow nodes with matching checksums are counted (the “matching pattern count”) versus the total number of flow nodes (the “total pattern count”). A “commonality path” is created that records the matched checksum and total accumulated matching pattern count (“common score”). Multiple commonality paths are created based upon this data. On subsequent iterations of flow nodes, the flow nodes with matching checksums are again compared, and the commonality paths are updated. Since the matching pattern count at each step in the commonality paths are known, the commonality paths can be grouped from most to least common. Table 3 shows an example of commonality paths (score represents “common score” for commonality path). The paths are listed with scores below them.

TABLE 3

| | | | |
|---|---|---|---|
| A | A-A | A-A-B | A-A-B-B |
| Score: 4 | Score: 4 + 3 | Score: 4 + 2 + 2 | Score: 4 + 2 + 2 + 1 = 9 |
| | A-B | A-B-C | A-B-C-D |
| | Score: 4 + 1 | Score: 4 + 1 + 1 | Score: 4 + 1 + 1 + 1 = 7 |
| | | A-A-C | A-A-B-C |
| | | Score: 4 + 2 + 1 | Score: 4 + 2 + 2 + 1 = 9 |
| | | | A-A-C-A |
| | | | Score: 4 + 2 + 1 + 1 = 8 |

For presenting behavior patterns, the highest scoring commonality paths are shown, with a breakdown of the events that make up that commonality path. No personal data is shown to the administrator, only data related to how common each path is and the events that make up the commonality paths. Table 4 shows an example of sorted commonality paths.

TABLE 4

| Sort Order | Path | Score |
|---|---|---|
| 1 (tie) | A-A-B-B | 9 |
| 1 (tie) | A-A-B-C | 9 |
| 3 | A-A-C-A | 8 |
| 4 | A-B-C-D | 7 |

In one embodiment, a token can be provided for each user exchange or session with a website and/or webserver 12. The user can be either a registered user or a guest user, i.e., a user who has not registered or authenticated with the user analytics server 55. The tokens provided for a registered user enable the user analytics system 52 to associate event data to particular anonymous “identification” information in the user analytics data 63. The stored event data can be encrypted by the user analytics server 55 to provide additional security to the user analytics data 63. A registered user can access the user analytics server 55 to view the actual, i.e., unencrypted, event data in the user analytics data 63 relating to that user. A guest user can also use a token for each exchange or session, but there is no association between the provided token and a guest user. In other words, every session involving a guest user is handled as if a new guest user is present even if the guest user identity has not changed. Token generation is randomized based upon entropy from the user analytics server 55 possibly combined with data generated from a Physically Unclonable Function (PUF), such as environmental noise from various device drivers that ensure the data generated is non-deterministic and hard for an outside observer to measure.

In the embodiments described above, the analytics module 50 is shown as running or operating on the webserver 12, and the user analytics system 52 is shown as running or operating on the user analytics server 55 that is remote from the webserver 12. In other embodiments, other configurations are possible. As an example, it is possible for the user analytics system 52 to run or reside on the webserver 12 and for the analytics module 50 to run or reside on the user devices 15. Various other changes and modifications would be apparent to a person of ordinary skill upon reading this disclosure.

In addition, the webserver 12 is also described above as hosting a website defined by website data 22. Note that the website data 22 may include a Hyper Text Markup Language (HTML) document and other types of data typically used to provide webpages. The website may be designed for use on user devices 15 of various sizes. In some cases, a website or other data source may be specifically designed for use on small-scale mobile devices, such as, but not limited to, smartphones. Software for providing a website for a small-scale mobile device is sometimes referred to as a “mobile web application.” In addition, it is possible for the webserver 12 to include a native language application that is specifically designed for use with user devices 15 having a certain operating system. For example, the application may be specifically tailored for iOS, Android, or Windows Mobile devices. The user analytics system 52 may be configured for use with any of these types of user data sources as well as others. Moreover, for the various types of user data sources that may be provided by the webserver 12, the general configuration and operation of the user analytics system 52 can be the same as described above.

The user analytics system can be implemented on a website, mobile web application, native language mobile application, connected system and/or network. A website may be any collection of pages viewable by a web browser application running on desktop and mobile devices. The website code is modified, with a single snippet added, to activate the analytical system for that specific website. From that point forward, the events that take place by users on that website can be tracked in the user analytics system of the analytical system. A mobile web application may be a mobile-enhanced website or mobile stand-alone application that runs a local web-based application on the device. The process for implementing the analytical system for a mobile web application is the same as for a normal website. In one possible embodiment, the analytics module 50 and user analytics system 52, described above may be configured to track and exchange data on the percentage of users employing specific operating systems, mobile devices, browsers and/or other data on user devices 15 and/or the software related thereto. Analytics module 50 may be configured to visualize and/or display said data to website, mobile application, connected system and/or network administrators as well as any other authorized user in a manner similar to that already described.

A native language mobile application implements the analytical system differently due to the distinctly different architecture of these mobile applications. These mobile applications use a web-based application programming interface (API) to talk directly to the analytics system server. The interface includes support for tracking navigation across various screens within a mobile application. The interface supports sending event information to track various types of events that include screen loading, screen leaving (to another screen), tap gestures for elements on the screen, and scroll gestures on the screen. Additional parameters may be provided when sending this event data to the user analytics server 55, including a unique identifier for the element of interest (when tapped on), the positional coordinates on the screen (in pixels) where an event occurred, and the specific device and operating system details of the user. Additionally, the user analytics system of the analytical system will automatically maintain the history and thread of events associated with that user's session of the mobile application and track times of the events internally. Additional connected systems include software that implement the analytical system utilizing a web-based API as well. A connected system could be any system with an interface to accept user input and record the inputs of that user. Examples of such connected systems may include, but are not limited to, kiosks, gaming consoles, NFC terminals, Smart TVs, other similar data input, output and/or communication devices, sensors and/or smart things.

Additionally, websites and mobile applications may implement the analytical system via one or more communication interfaces (email, text messages, push notifications, etc.) These implementations will rely on a separate web-based API, which provides an interface for building and sending emails, text messages, and push notifications with the capability of receiving and tracking user behavior/responses to these items.

In other embodiments, the user privacy and security system 60 can be used with other systems and applications besides a user analytics system. For example, the user privacy and security system 60 can be used with a hashtag and/or geotag management system or a reputation management system. An example of a hashtag management system that can be used with the present application is described in commonly-assigned U.S. patent application Ser. No. 14/921,757, entitled “Systems and Methods for Managing Hashtags” and filed on Oct. 23, 2015, which is incorporated herein by reference. An example of a reputation management system that can be used with the present application is described in commonly-assigned U.S. patent application Ser. No. 14/921,767, entitled “Systems and Methods for Reputation Management” and filed on Oct. 23, 2015, which is incorporated herein by reference.

Embodiments within the scope of the present application include program products with machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions include, for example, instructions and data which cause a general purpose computer, special purpose computer, or special purpose processing machine to perform a certain function or group of functions. Software implementations could be accomplished with standard programming techniques, with rule based logic and other logic to accomplish the various connection steps, processing steps, comparison steps and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A computer implemented method of providing user privacy and security, the method comprising:
receiving, at a module, a token from a server, wherein the token is associated with an anonymous user and is to be used for communication with the server;
incorporating, by the module, the token into a packet, wherein the packet includes data associated with the anonymous user;
transmitting the packet to the server;
verifying the data in the packet corresponds to the token incorporated into the packet; and
parsing the data from the packet and storing the data at the server.

2. The method of claim 1, further comprising applying a hash function to the token prior to the step of incorporating the token into the packet.

3. The method of claim 2, further comprising encrypting the packet prior to the step of transmitting the packet, and wherein the step of verifying the data includes decrypting the packet from the module.

4. The method of claim 1, further comprising generating the token at the server in response to receiving a communication from the module, wherein the token includes information in the communication from the module.

5. The method of claim 4, wherein the step of generating the token includes dynamically generating the token for each user session monitored by the module.

6. The method of claim 1, wherein the token includes identification information corresponding to the anonymous user.

7. The method of claim 6, wherein the anonymous user is a registered user with the sever and the identification information corresponds to the registered user.

8. The method of claim 6, wherein the anonymous user is a guest user and the identification information includes random data.

9. The method of claim 6, wherein the step of storing the data includes storing the identification information from the token.

10. An analytics system providing user privacy and security, the system comprising:
a first server, the first server comprising an analytics tracker configured to generate analytical data about one or more of a website, mobile application, connected system or network and a privacy and security system to anonymize user data from the one or more of the website, mobile application, connected system or network;
a second server connected to the first server by a network, the second server comprising an analytics module configured to enable the second server to provide analytics information about the one or more of the website, mobile application, connected system or network to the first server to generate the analytical data, wherein the analytics information includes information about user activity at the one or more of the website, mobile application, connected system or network hosted by the second server;
the privacy and security system configured to provide a token to the analytics module to anonymize user information in the analytics information provided to the analytics tracker;
the analytics module configured to incorporate the token from the privacy and security system into a data packet providing the analytics information to the analytics tracker; and
the analytics tracker configured to verify the analytics information from the analytics module using the token and store the analytics information from the analytics module.

11. The system of claim 10, wherein the analytics module is configured to hash the token prior to incorporating the token into the data packet.

12. The system of claim 10, wherein the data packet includes the token, the analytics information, and identifying data associated with a user device accessing the one or more of the website, mobile application, connected system or network.

13. The system of claim 12, wherein the analytics tracker is configured to compare the identifying data in the data packet to address information in the token to verify the analytics information.

14. The system of claim 10, wherein the token includes address information, information on at least one of the web browser or operating system of a user device accessing the one or more of the website, mobile application, connected system or network, random data and identification information.

15. The system of claim 14, wherein:
the identification information corresponds to one of a registered user or random data for a guest user; and
the analytics tracker is configured to store identification information from the token in the data packet.

16. The system of claim 14, wherein the analytics tracker is configured to use pattern analysis to generate analytical data about the one or more of a website, mobile application, connected system or network.

17. The system of claim 10, wherein the analytics tracker and the privacy and security system are configured to enable one or more of facilitation or management at least one of user reputations, search, discovery, hashtags or geotags.

18. A computer implemented method of accessing anonymously stored information, the method comprising:
storing, by a server, anonymous information, wherein at least a portion of the stored anonymous information is associated with a registered user;
requesting, by a registered user, stored information associated with the registered user from the server;
parsing, by the server, data packets of anonymous information stored by the server to identify information associated with the registered user;
assembling, by the server, the identified information associated with the registered user; and
providing, by the server, the assembled information to the registered user.

19. The method of claim 18, wherein the step of providing the assembled information includes encrypting the assembled information using key information provided by the registered user.

20. The method of claim 18, wherein the step of parsing data packets includes:
reviewing data packets for identifying information; and
determining whether identifying information from a reviewed data packet can be decrypted using a private key provided in the request for information from the registered user.
